(19) United States
(12) Patent Application Publication
(10) Pub. No.: US 2009/0295796 A1
(43) Pub. Date: Dec. 3, 2009

(54) METHOD OF UPDATING A MODEL

(76) Inventors: Clayton D. Brown, Colchester, CT (US); Daniel Robert Bolduc, Agawam, MA (US); Willoughby Marshall Quin, North Haven, CT (US); James J. Toczko, East Hampton, CT (US)

Correspondence Address: CARLSON, GASKEY & OLDS/PRATT & WHITNEY, 400 WEST MAPLE ROAD, SUITE 350, BIRMINGHAM, MI, 48009, US

(21) Appl. No.: 12/129,645

(22) Filed: May 29, 2008

(51) Int. Cl. G06T 17/40

(52) U.S. Cl. 345/420

(57) ABSTRACT

An example method of updating a model includes locating points on a part, establishing a reference dimension using the point locations, and updating the model using the reference dimension.

### BACKGROUND OF THE INVENTION

This invention relates generally to updating a computer-generated three-dimensional model based on collected measurements from representative samples.

As known, a wide range of industries represent parts using three-dimensional (3D) computer based (CAD) models. The dimensions of these 3D models may represent the dimensions of actual parts, desired parts, or a combination thereof. Example uses for 3D models include referencing the 3D model when establishing cutter paths for machining or conducting assembly feasibility studies. These models can also be used in conjunction with the stereolithography process to create a copy of the 3D model in plastic or another suitable material. Many industries, especially those that monitor dimensional changes due to manufacturing variation, want 3D models to compare dimensional differences between manufactured parts.

Creating a 3D model often involves entering initial measurement information into computer 3D modeling software. The measurement information typically includes a dimension and a dimension location. Additional measurement information is then manually entered into the modeling software to update the 3D model. Measurements taken from actual parts may provide the additional measurement information, for example.

Disadvantageously, measuring parts often requires an operator to repeat measurements at the same dimension location on more than one part. Alternatively, entering updated measurement information into the modeling software may involve entering both a dimension and a dimension location. These options are often laborious, prone to inaccuracies, and employed only in the initial creation of a 3D model.

### SUMMARY OF THE INVENTION

An example method of updating a model includes locating points on a part, establishing a reference dimension using the point locations, and updating the model using the reference dimension.

The example method may include communicating the model dimension to a computer modeling program, such as UNIGRAPHICS, for incorporation into the part model and establishing the reference dimension using point locations from more than one part. The method may both locate a point on the part and establish the reference dimension using data inspection computer software, such as GEOMAGIC. This method provides a statistically based nominal dimension using the measurements collected from many parts. Further, the use of data inspection computer software often provides information, helping establish the variance or tolerance band surrounding the nominal dimension. This tolerance band is useful when creating manufacturing drawings.

The example method of updating a model may include choosing a location for a dimension identifier, determining a first dimension of a first part at the location, and then establishing a model dimension associated with the dimension identifier using the first dimension. The method then updates a part model at the location based on the model dimension. The method may include determining a second dimension of a second part at the location and then calculating a trend between the first dimension and the second dimension to establish the model dimension. This trend analysis can be automated to permit the inclusion of additional sample measurements.

### BRIEF DESCRIPTION OF THE DRAWINGS

The various features and advantages of this invention will become apparent to those skilled in the art from the following detailed description of an embodiment of the invention. The drawings accompanying the detailed description can be briefly described as follows:

FIG. 1 shows a schematic sectional view of an example gas turbine engine;

FIG. 2 shows the flow of an example method for updating a 3D model of the FIG. 1 gas turbine engine;

FIG. 3 shows an example of locating points on a compressor disk portion according to the FIG. 2 method;

FIG. 4 shows an end view of the compressor disk portion with example reference dimensions used in the FIG. 2 method;

FIG. 5 shows an example of establishing model dimensions according to the FIG. 2 method; and

FIG. 6 shows an example model of a compressor disk updated using the FIG. 2 method.

### DETAILED DESCRIPTION OF AN EXAMPLE EMBODIMENT

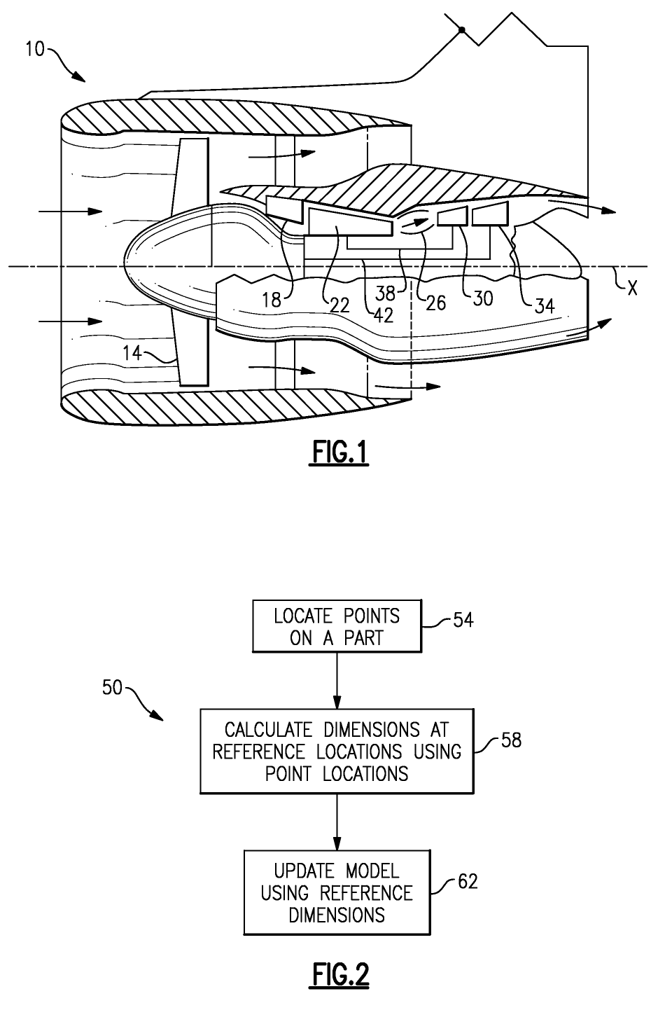

FIG. 1 schematically illustrates an example gas turbine engine 10 including (in serial flow communication) a fan section 14, a low pressure compressor 18, a high pressure compressor 22, a combustor 26, a high pressure turbine 30, and a low pressure turbine 34. The gas turbine engine 10 is circumferentially disposed about an engine centerline X.

During operation, the compressors 18, 20 pressurize air that the fan section 14 pulls into the gas turbine engine 10. The resulting pressurized air is then mixed with fuel and burned in the combustor 26. Hot combustion gases generated within the combustor 26 flow through high and low pressure turbines 30, 34, which extract energy from the hot combustion gases. The turbines 30, 34 utilize the extracted energy to power the high pressure compressor 22 and the low pressure compressor 18 through shafts 38, 42.

FIG. 2 illustrates an example method 50 of updating models of parts within the gas turbine engine 10 of FIG. 1. In this example, the method 50 updates three-dimensional (3D) part models of gas turbine engine parts, but is not limited to updating such models. As another example, the method 50 could be used when updating parts within other types of gas turbine engines or parts unrelated to gas turbine engines, such as automotive parts.

The example method 50 first locates points on a part at 54. Next, at 58, the method 50 calculates dimensions at reference locations using the points from 54. Identifiers may identify the reference locations, for example. The dimensions of the model at the reference locations are then updated at 62 using the dimensions.

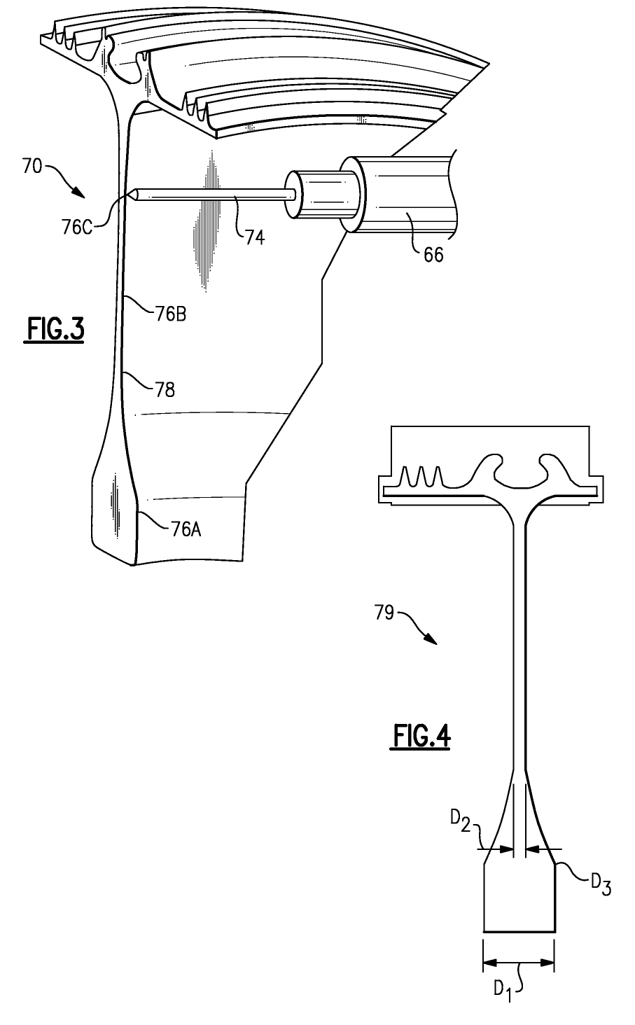

Referring now to FIG. 3 with continuing reference to FIG. 2, in this example, a coordinate measuring machine (CMM) 66 locates points on a gas turbine engine compressor disk 70, a type of part. As known, locating points may include using an X-Y-Z grid to determine a point location on a worktable. A CMM probe 74 extends to contact the disk 70 at a plurality of points 76a, 76b, 76c along an edge 78. For drawing clarity, only three points 76a, 76b, 76c are shown. Other examples may include contacting the edge 78, and other areas of the disk 70, at points spaced quite closely, say 0.001 inches (0.0254 millimeters) apart.

Known computer software can determine dimensions of the disk 70 using the locations of the points 76a, 76b, 76c. An example of such computer software includes GEOMAGIC computer-aided inspection tool software. The example computer software determines dimensions of the disk 70 at locations corresponding to dimension identifiers D₁, D₂, D₃, and may generate a dimensioned drawing 79 of the disk 70 similar to the that shown in FIG. 4. The dimensions associated with identifiers D₁, D₂, D₃ are determined by locating points on the disk 70 rather than by measuring the disk 70. Example dimensions include the linear measurements corresponding to identifiers D₁ and D₂, and the radial measurement corresponding to identifier D₃.

The identifiers D₁, D₂, D₃ correspond to the same location, such as a disk 70 thickness at the bottom of the disk 70, regardless of the exact disk 70 measurements. Thus, although the measurements may vary, the same dimensions of the disk 70 are determined regardless of the exact locations of the points 76a, 76b, 76c from FIG. 3. As an example, even though the probe 74 may contact a second disk at different points, which would provide different location information, those different points still establish the width of the second disk at dimension identifier D₁. Thus, establishing the dimensions of the disk 70 does not require repeated and precise placement of the probe 74.

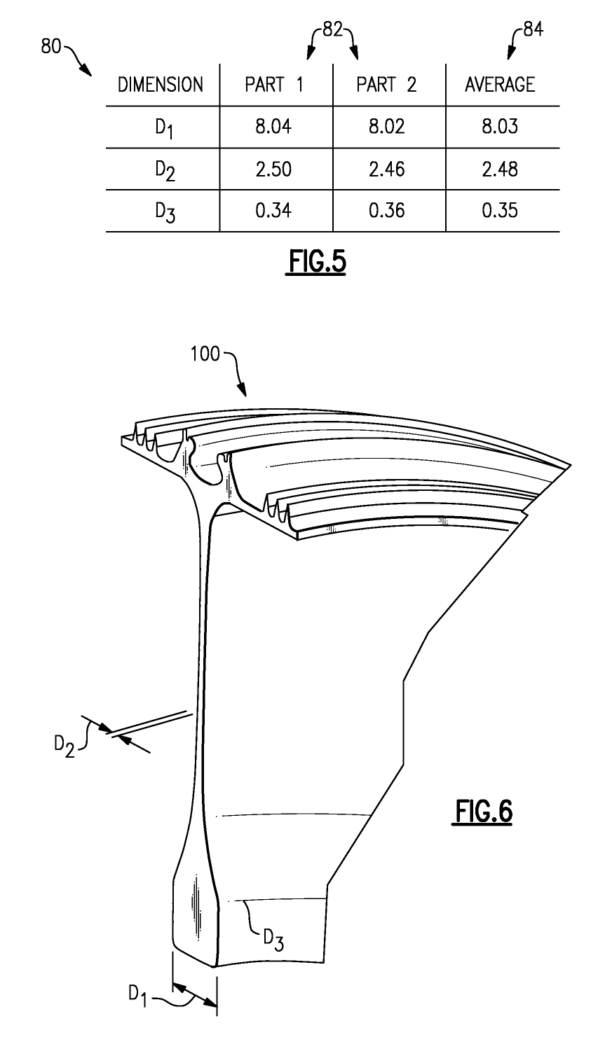

Establishing the identifiers D₁, D₂, D₃ corresponding to the same dimension locations facilitates part comparisons, as shown a comparative table 80 of FIG. 5. The example comparative table 80 only includes three dimension identifiers D₁, D₂, D₃ for clarity. Other examples may include several additional identifiers. The table 80 includes a group of dimension data measurements 82 corresponding to the locations of the dimension identifiers D₁, D₂, D₃.

Analysis of the dimension data may include establishing dimension measurements by calculating data averages 84, for example. The data averages 84 provide an average dimension measurement corresponding to the dimension identifiers D₁, D₂, D₃. Other analysis may include establishing ranges for the data from multiple parts, determining standard deviations, or other trend analysis or statistical tools.

The comparative table 80 is an Excel-based spreadsheet file, for example, which a computer 3D modeling software imports as updates are made. Example updates may include adding dimension data to the comparative table 80 from additional parts or an updated data analysis. In this example, the method 50 (FIG. 2) communicates the average dimensions to computer 3D modeling software, such as UNIGRAPHICS based software. The 3D modeling software uses the average dimensions as model dimensions in this example.

Referring now to FIG. 6, the computer 3D modeling software generates a 3D disk model 100 using model dimensions, which correspond to the dimension identifiers D₁, D₂, D₃ from the FIG. 5 comparative table 80. The resultant computer model 100 thus represents the dimensional data averages 84 from two parts that provided dimension data to the comparative table 80.

Using dimension identifiers D₁, D₂, D₃ facilitates model updates because the locations of the model dimensions do not have to be determined when making model updates. Instead, the computer 3D modeling software can rely on the measurements associated with dimension identifiers D₁, D₂, D₃ as corresponding to the same model locations.

As the average dimensions associated with dimension identifiers D₁, D₂, D₃ communicate directly to the 3D modeling software, the dimensions of the 3D disk model 100 fluctuate with the average dimensions. For example, if the average dimensions increase over time, so to do the model dimensions of the 3D disk model 100.

Although a preferred embodiment of this invention has been disclosed, a worker of ordinary skill in this art would recognize that certain modifications would come within the scope of this invention. For that reason, the following claims should be studied to determine the true scope and content of this invention.

We claim:

1. A method of updating a model, comprising the steps of:
(a) determining a plurality of point locations on a first part;
(b) establishing a reference dimension using the plurality of point locations; and
(c) updating a part model based on the reference dimension.

2. The method of claim 1, including the step of:
(d) calculating a model dimension using the reference dimension.

3. The method of claim 2, including the step of:
(e) communicating the model dimension to a computer modeling program for incorporation into the part model.

4. The method of claim 2, including the step of:
(e) changing the part model based on the model dimension.

5. The method of claim 2, wherein the model dimension incorporates differences between the plurality of point locations on the first part and a plurality of point locations on a second part.

6. The method of claim 2, including the step of:
(e) associating the reference dimension and the model dimension with a dimension identifier.

7. The method of claim 1, wherein said step (a) includes determining the plurality of point locations using a coordinate-measuring machine.

8. The method of claim 1, wherein said step (b) includes establishing the reference dimension using computer-aided inspection tool software.

9. The method of claim 8, wherein the computer-aided inspection tool software is GEOMAGIC software.

10. The method of claim 1, wherein the part model comprises a UNIGRAPHICS model.

11. The method of claim 1, wherein the part model comprises a 3D part model.

12. A method of updating a model, comprising the steps of:
(a) choosing a location for a dimension identifier;
(b) determining a first dimension of a first part at the location;
(c) establishing a model dimension associated with the dimension identifier using the first dimension; and
(d) updating a part model at the location based on the model dimension.

13. The method of claim 12, including the step of:
(e) establishing a location of a plurality of points to determine the first dimension.

14. The method of claim 13, wherein the part model comprises a 3D part model.

15. The method of claim 13, including automatically communicating the model dimension to a computer modeling program for updating the model.

16. The method of claim 12, including the step of:
(e) determining a second dimension of a second part at the location;

17. The method of claim 16, including the step of:
(f) calculating a trend between the first dimension and the second dimension to establish the model dimension.

18. The method of claim 16, wherein the model dimension is an average of the first dimension and the second dimension.
